(19) United States
(12) Patent Application Publication
(10) Pub. No.: US 2023/0318273 A1
(43) Pub. Date: Oct. 5, 2023

(54) CABLE CLEAT WITH DOUBLE HEMMED CLAMPING FLANGE

(71) Applicant: Panduit Corp., Tinley Park, IL (US)

(72) Inventors: Andrew Crouse, Bolingbrook, IL (US); Rodney G. Rouleau, Manhattan, IL (US)

(73) Assignee: Panduit Corp., Tinley Park, IL (US)

(21) Appl. No.: 17/708,643

(22) Filed: Mar. 30, 2022

(51) Int. Cl. H02G 3/04; F16L 3/12

(52) U.S. Cl. CPC H02G 3/0456; F16L 3/12

(57) ABSTRACT

A cable cleat assembly designed to secure cables during short circuit events. The cable cleat assembly is formed from a one-piece metal shell. The metal shell includes a bottom, sides extending from the bottom, and clamping flanges extending from the distal end of each side. The clamping flanges are double hemmed clamping flanges to reinforce the cable cleat assembly.

### FIELD OF THE INVENTION

The present invention relates to a cable cleat, and more particularly to a cable cleat with a double hemmed clamping flange.

### BACKGROUND OF THE INVENTION

Cable cleats are designed to contain cables during a three-phase short circuit event. The electromagnetic fields during a short circuit event can exert high forces on the cables resulting in significant damage if the cables are not held in place. The force exerted on the cable cleat is dependent on the short circuit fault current and the distance between the center of the conductors. During a short circuit event, there can be several failure modes. The cable jackets may tear which could cause exposed wires that would allow current to flow to metal objects. Another example of a failure is that the nut and washer threaded to the clamping bolt securing the cable cleat could pull through the bolt hole allowing the cables to come loose during the short circuit event potentially damaging equipment, property, and personnel.

One example of a cable cleat that is includes a hinged two-piece shell with hemmed outer edges along the two-piece shell. The hemmed outer edges are rounded thereby eliminating the need for a protective liner in the cable cleat. The cable cleat can be formed from stainless steel sheets to create flat blanks that form the upper and lower shells. The process required to bend and finish the cleats can vary but additional steps are required to fold the hemmed outer edges. The bending process to form the hinges and shell curves is common to both hemmed and unhemmed cable cleats. Alternatively, the cable cleat may be created from a roll formed strip. A flat coil of stainless steel is fed into a roll forming line. The flat coil of stainless steel is folded in the roll forming process to create the hemmed outer edges. The hemmed stainless strip can be notched and formed into upper and lower shells. This manufacturing method eliminates some of the scrap associated with flat sheets, but it still produces a moderate amount of scrap. The roll forming process replaces some of the flat blank hem forming steps during manufacture. The roll forming process is quicker than the hem forming process associated with flat blanks. The process of creating the hinges is the same for all hinged cleats. One end of the shell is notched and curled into a barrel that will accept a hinge pin.

Another example of a cable cleat includes an unhemmed two-piece shell. The unhemmed cleats require a protective liner to prevent cable damage that could occur during a short circuit event or during thermal expansion and contraction. The main advantage of an unhemmed cable cleat is the manufacturing process. A slit coil of stainless steel is easily fed into a series of punch dies and forming presses. For a two-piece shell, the process could be a batch process that makes the upper and lower shells separately. The upper and lower shells would then be joined at the hinge and welded to create the completed cleat assembly.

Another example of a cable cleat includes an unhinged one-piece shell with clamping flanges and unhemmed outer edges, e.g., Ellis Patents Vulcan cable cleat. This standard duty cable cleat is designed and offered to be a low-cost option when short circuit forces are moderate. The stainless steel shell is typically a thinner gauge than that of a heavy-duty cable cleat and the edge of the one-piece shell body is not rounded. Thus, the one-piece shell requires a protective liner to prevent cable damage. As illustrated in FIG. 1, the clamping flanges 12 include a typical single hem 14 which provides a weak spot in the cable cleat 10. As discussed above, the clamping bolt or washer and nut can pull through the clamping bolt hole 16 during a short circuit event. As a result, the clamping flange needs to be reinforced with a shim or washer. The clamping bolt hole has another weakness in that a typical carriage bolt used for clamping cannot be used. There is not enough material in the clamping flange of the cable cleat to keep the carriage bolt from turning during tensioning. As a result, the typical clamping carriage bolt is replaced with a hex head bolt. To keep the hex head bolt from turning a molded bolt keeper has also been added to the clamping flange. The clamping flange hem extends past the bend to help reinforce the area. The manufacturing process of this type of cable cleat has a high material utilization. A coil of stainless steel is fed into a series of punching and forming dies. The dies first cut a strip of material from the coil. The hem for the clamping flanges is folded and then the clamping bolt hole is punched. The slugs from the clamping bolt hole are the only stainless steel scrap from the manufacturing process. Once the basic shell is formed, the clamping flange shims must be installed and welded in place. The clamping flange shims have a pre-punched hole. The hole must be aligned with the clamping bolt hole prior to and during welding. The molded bolt keeper and protective liner would be added as part of the final assembly process.

Another example cable cleat includes a hinged two-piece shell with unhemmed outer edges, e.g., CMP Product's Patriot cable cleat. The unhemmed hinged two-piece shell cable cleat was designed and offered to be a lower cost option when short circuit forces are moderate. The stainless steel shell is a thinner gauge than heavy duty cable cleats and the outer edges of the shell body are not rounded. As a result, the shell requires a protective liner to prevent cable damage. The cable cleat also includes single hem clamping flanges which, as discussed above, result in a weak spot during short circuit events. First, the clamping bolt will pull though the clamping bolt hole during a short circuit event thus it needs to be reinforced with a shim or washer. Additionally, there is not enough material to keep a carriage bolt from turning during tensioning. As a result, the typical clamping carriage bolt is replaced with a hex head bolt. To keep the hex head bolt from turning during tensioning, a molded bolt keeper has been added to each clamping flange. The manufacturing process of the hinged two-piece shell with unhemmed outer edges cable cleat has a lower stainless steel material utilization than other designs. A coil of stainless steel is fed into a series of punching and forming dies. The dies first cut a strip of material from the coil. The hem for the clamping flanges is folded and then the clamping bolt hole is punched. The size and shape of the shell are then formed by other dies. Once the basic shell is formed, the clamping flange shims must be installed and welded in place. The clamping flange shims have a pre-punched hole. The hole must be aligned with the clamping bolt hole prior to and during welding. The molded bolt keeper and protective liner are added as part of the final assembly process.

Although there are many cable cleat options, it would be desired to provide an improved cable cleat that is designed to have optimized performance and a low manufacturing cost.

### SUMMARY OF THE INVENTION

A cable cleat assembly designed to secure cables during short circuit events. The cable cleat assembly includes a one-piece metal shell. The one-piece metal shell has a bottom, sides extending from the bottom, and clamping flanges extending from the distal end of each side. The clamping flanges are double hemmed clamping flanges. Each double hemmed clamping flange includes a clamping bolt hole designed to receive a fastener to secure the cable cleat assembly. The double hemmed clamping flanges reinforce the cable cleat assembly thereby prevent failures during short circuit events.

### BRIEF DESCRIPTION OF THE DRAWINGS

FIG. 1 is a perspective view of a prior art cable cleat with a single hem clamping flange.

FIG. 2 is a perspective view of the cable cleat of the present invention with a double hemmed clamping flange.

FIG. 3 is a perspective view of the cable cleat of FIG. 2 with a spacer installed in the cable cleat.

FIG. 4 is a perspective view of the lower spacer of the cable cleat of FIG. 3.

FIG. 5 is a perspective view of the cable cleat of FIG. 3 with an upper spacer positioned to be installed.

FIG. 6 is a perspective view of the cable cleat of FIG. 3 securing a trefoil cable configuration.

FIG. 7 is a perspective view of the cable cleat of FIG. 3 securing a quad cable configuration.

FIG. 8 is a perspective view of the cable cleat of FIG. 3 securing a single cable.

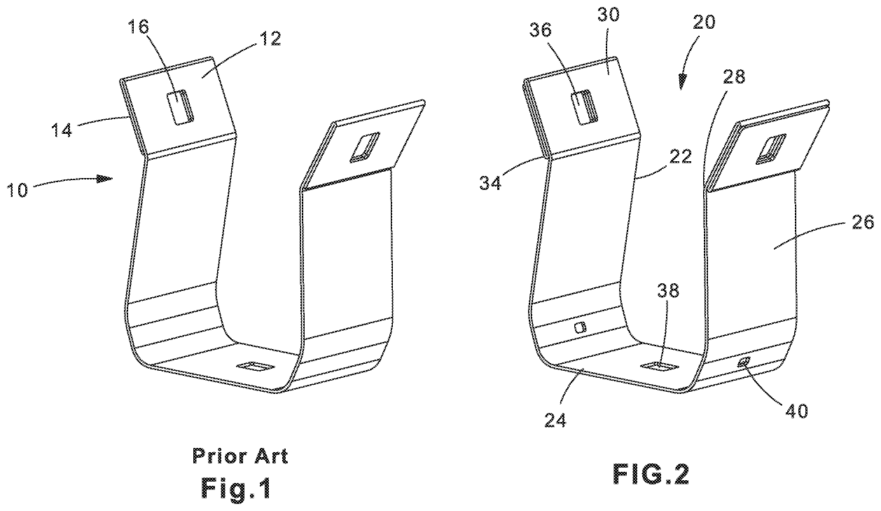

### DETAILED DESCRIPTION

FIG. 2 illustrates a cable cleat 20 with a clamping flange 30 having a double hem 34 of the present invention. The cable cleat 20 includes a one-piece metal shell 22. The formed one-piece shell 22 includes a bottom 24, two sides 26 extending from the bottom 24, and two clamping flanges 30 at the distal end 28 of the sides 26. The one-piece shell 22 does not include a folded hem along the outer edges of the shell as described above with respect to prior art cable cleat shells. Instead, the one-piece metal shell 22 includes rounded edges 32. The rounded edge design of the present invention eliminates the need for a protective liner. As a result, the rounded edge shell reduces manufacturing costs by eliminating the protective liner as well as simplifying the manufacturing process by eliminating the need to install a protective liner.

The cable cleat 20 of the present invention also does not include a hinge. A thinner gauge stainless steel material can be used for the cable cleat 20. The cable cleat manufactured from thinner gauge stainless steel can be manipulated with very little effort. As a result, the cable cleat 20 can be formed from a one-piece shell 22 thereby eliminating the need of a hinge as required in various prior art cable cleats. The elimination of the hinge reduces the scrap produced while creating the hinge and the need for tooling to form the hinge.

At the distal end of the sidewalls, the metal shell is folded over itself multiple times to form clamping flanges 30 having a double hem 34. The double hemmed 34 clamping flanges 30 reinforce the shell 22 of the cable cleat 20. The double hemmed 34 clamping flanges 30 also eliminate the need for shims to strengthen the clamping flanges 30. The clamping flange bolt holes 36 are punched after the metal is folded which facilitates in assembling the cable cleat 20. Welds could also be added to the double hemmed clamping flange 30 to increase the strength of the clamping flange 30, if desired. Additionally, an oversized washer (not illustrated) can be used, if desired, to distribute the clamping force over a larger area and greatly reduce the possibility of the bolt, washer, and nut from pulling through the clamping bolt holes 36.

The cable cleat 20 includes one thru hole 38 at the bottom 24 of the shell 22 for mounting. The thru hole 38 will be sized for a 10 mm carriage bolt or other type of 10 mm bolt. As discussed below, the cable cleat 20 also includes punched holes 40 in the sides 26 of the shell 22 for receiving the attachment tabs 66 of a spacer 50.

Cable cleats are normally attached by a fastener directly to a ladder rung or by a bracket attached to the ladder rung. To avoid any damage, cable cleats holding a single or multi conductor cable should not come into contact with the head of the mounting fastener. A spacer is typically installed in the cable cleat to protect the cable from the head of the fastener during short circuit events and cable movement during expansion and contraction. The spacer also enables the cable cleat to receive a range of cable diameters.

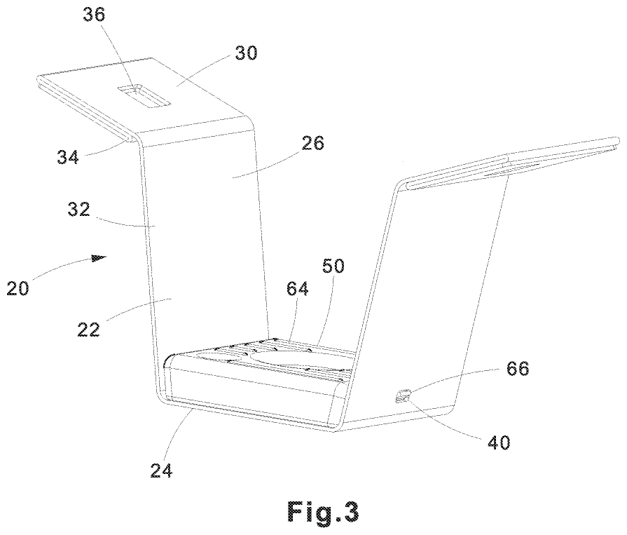

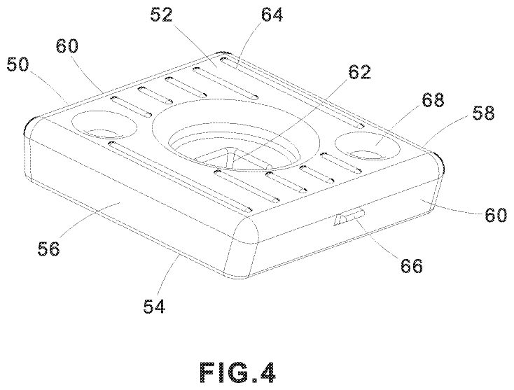

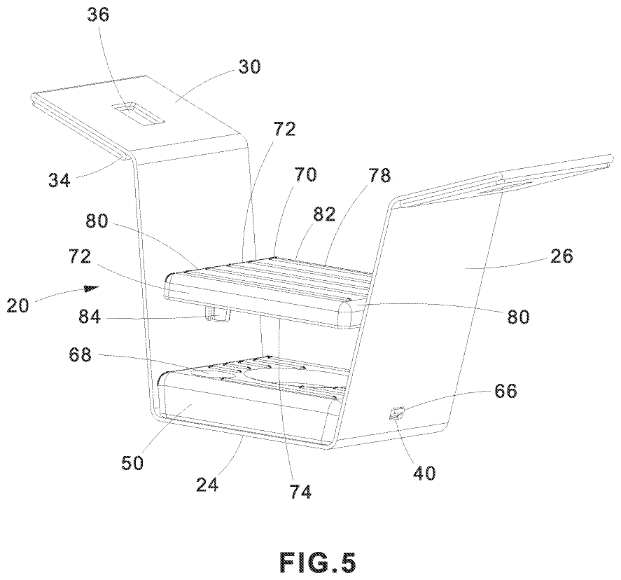

As illustrated in FIG. 3, the cable cleat 20 of the present invention includes a spacer 50. FIG. 4 illustrates a perspective view of the spacer 50. The spacer 50 is rectangular with a top 52, a bottom 54, a front 56, a back 58, and two opposing sides 60. The spacer 50 includes a center opening 62 extending from the top 52 to the bottom 54 for receiving the fastener used to secure the cable cleat 20 to a ladder rack or to a bracket. The spacer 50 also includes a plurality of ribs 64 extending along the top 52. The ribs 64 reduce the axial movement of the cables installed in the cable cleat 20. Each side 60 of the spacer 50 includes an attachment tab 66 extending outwardly away from the spacer 50 at the center of the spacer 50. As described below with respect to FIG. 5, the top 52 of the spacer 50 includes two additional openings 68 for receiving interlocking connectors 84 of an upper or second spacer 70.

Many heavy duty or thicker gauge cable cleats attach spacers to cable cleat via fasteners, such as small screws. However, in the cable cleat 20 of the present invention, the cable cleat shell 22 is not thick enough to receive fasteners. As a result, the attachment tabs 66 extending from the spacer 50 of the present invention snap fit into the punched holes 40 in the sides 26 of the cable cleat shell 22. The attachment tabs 66 enable the spacer 50 to be secured to the cable cleat 20 without the use of fasteners or any adhesives.

As illustrated in FIG. 5, the cable cleat 20 may also include an upper or second spacer 70, if desired. The addition of an upper spacer 70 increases the cable diameter range for the cable cleat 20. The upper spacer 70 is rectangular with a top 72, a bottom 74, a front 76, a back 78, and two opposing sides 80. The top 72 of the upper spacer 70 includes a plurality of ribs 82 for increasing the axial force retention of the cable cleat 20. Interlocking connectors 84 extend from the bottom 74 of the upper spacer 70. The interlocking connectors 84 align with and engage the openings 68 in the spacer 50 enabling the upper spacer 70 to attach to the spacer 50 installed in the cable cleat 20. Thus, the spacer 50 and the upper spacer 70, if used, provides a cushion for the cable secured in the cable cleat 20 and protects the cable from the mounting bolt or other mounting hardware.

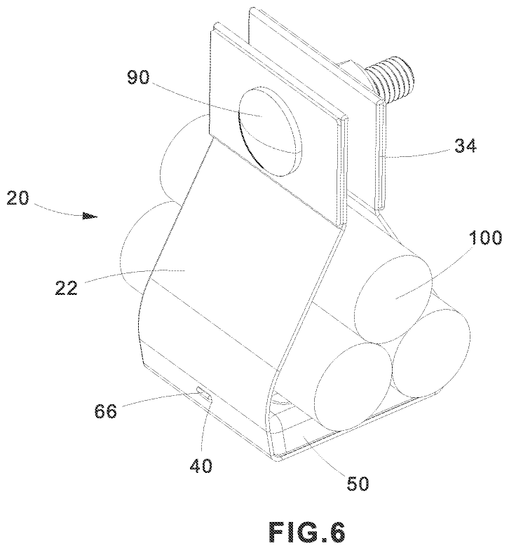

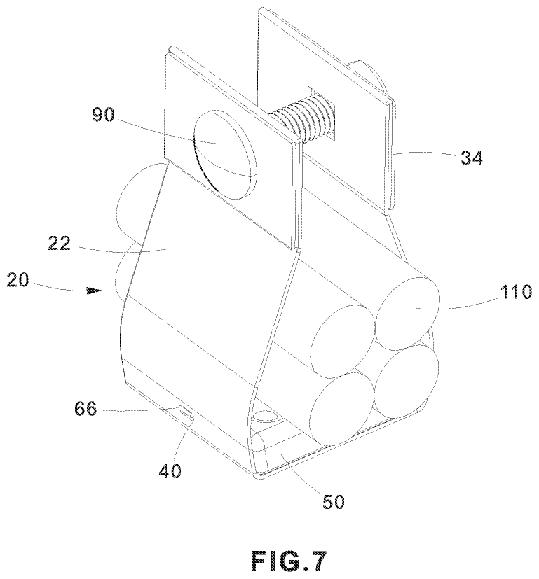

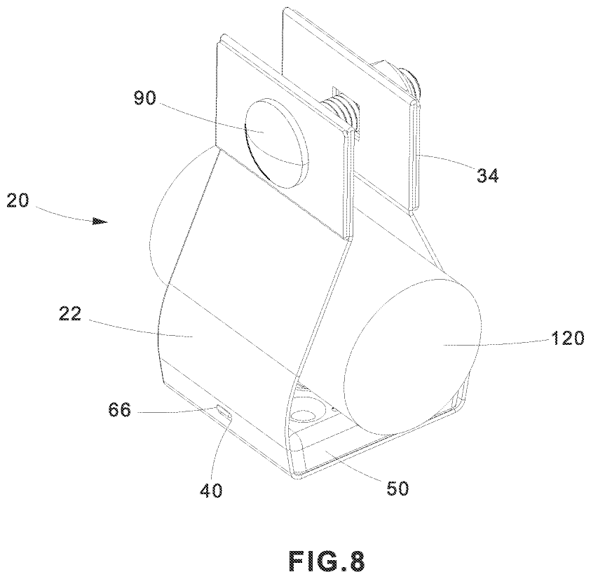

FIGS. 6-8 illustrate the cable cleat of the present invention secured by a fastener 90, such as a bolt and nut, holding cables in various configurations. As illustrated in FIG. 6, the cable cleat may be used to install cables in a trefoil configuration 100. As illustrated in FIG. 7, the cable cleat may be used to install cables in a quad configuration 110. As illustrated in FIG. 8, the cable cleat may be used to install a single cable 120.

The cable cleat 20 of the present invention is manufactured by first placing a fully rounded edge coil in a controlled payout system. The end of the rounded edge coil is fed through a series of straighteners. The straighten strip is then precisely fed into a die for mounting holes, pilot holes, and spacer holes. The strip is then cut from the coil. A controlled shuttling device grips the punched strip using the mounting and pilot holes for precision positioning and movement during the manufacturing process. The controlled shuttle moves the punched strip into forming dies to fold the double hemmed clamping flanges 30. The clamping flanges 30 may be welded together, if desired. The clamping bolt holes 36 are punched thru the double hemmed folded clamping flanges 30. The semi formed cleat is then positioned in a series of dies for final shaping. Finally, the clamping flange hardware, such as a carriage bolt, retaining washer, washer, and nylon lock nut, is added to the cable cleat.

The cable cleat 20 with the double hemmed clamping flanges 30 of the present invention provides many advantages. The double hemmed flange 30 created during the manufacturing process does not require reinforcements. The clamping flange bolt hole 36 is punched after the double hemmed clamping flange 30 is folded. Previous cable cleats are required to use pre-punched washers as rectangular shims to reinforce the clamping flange.

The edges 32 of the cable cleat 20 are fully rounded to protect cable jackets from being damaged during short circuit events. The rounded edges 32 also eliminates the need of an extra hem or a liner to protect the cables. The cable cleat 20 is manufactured from fully rounded edge strip material by folding or punching operations. The cable cleat 20 is made of a thinner material for a more-cost effective cable cleat.

The cable cleat 20 of the present invention does not include a hinge which reduces manufacturing costs by eliminating manufacturing steps, eliminates scrap created when a hinge barrel is formed, and eliminates the need of a hinge pin.

Furthermore, while the preferred embodiments of the present invention have been shown and described, it will be obvious to those skilled in the art that changes, and modifications may be made without departing from the teaching of the invention. The matter set forth in the foregoing description and accompanying drawings is offered by way of illustration only and not as limitation. The actual scope of the invention is intended to be defined in the following claims when viewed in their proper perspective based on the prior art.

1. A cable cleat assembly for securing cables during a short circuit event, the cable cleat assembly comprising:
a one-piece metal shell having a bottom, sides extending from the bottom, and clamping flanges extending from the distal end of each side;
wherein the clamping flanges are double hemmed clamping flanges for reinforcing the cable cleat assembly;
wherein each side of the one-piece shell having a punched hole positioned at an end of each side opposite the distal end and adjacent the bottom of the one-piece shell; and
a spacer having a top, a bottom, a front, a back and opposing sides, wherein each side having an attachment tab extending outwardly therefrom, wherein the attachment tabs are snap fit into the punched holes in the sides of the one-piece shell to secure the spacer and prevent movement of the spacer within the one-piece shell;
whereby the spacer supports the cables within the cable cleat assembly.

2. The cable cleat assembly of claim 1, wherein the one-piece shell having rounded outer edges.

3. The cable cleat assembly of claim 1, wherein each clamping flange has a hole for receiving a fastener to secure the cable cleat assembly.

4. The cable cleat assembly of claim 3, wherein the holes in the clamping flange are punched after the shell is folded to form the double hem.

5. The cable cleat assembly of claim 1, wherein the double hemmed flanges are welded for increasing the strength of the clamping flanges.

6. (canceled)

7. (canceled)

8. The cable cleat of claim 1, wherein the spacer having a plurality of ribs extending along the top of the spacer for increasing axial retention of the cables.

9. The cable cleat of claim 1, wherein the spacer having a center opening for receiving a fastener to secure the cable cleat assembly.

10. The cable cleat assembly of claim 1, further comprising an upper spacer having a top, a bottom, a front, a back, and opposing sides, wherein ribs extend from the top of the upper spacer for increasing axial retention of the cables; and wherein interlocking connectors extend from the bottom of the upper spacer.

11. The cable cleat assembly of claim 10, wherein the spacer having openings in the top, wherein the interlocking connectors of the upper spacer engage the opening in the top of the spacer to secure the upper spacer to the spacer.
